(19) United States
(12) Patent Application Publication
(10) Pub. No.: US 2010/0070475 A1
(43) Pub. Date: Mar. 18, 2010

(54) DATA BACKUP SYSTEM AND METHOD THEREOF

(76) Inventor: Liang-Chi CHEN, Hsinchih Taipei Hsien (TW)

Correspondence Address: Muncy, Geissler, Olds & Lowe, PLLC, P.O. BOX 1364, FAIRFAX, VA, 22038-1364, US

(21) Appl. No.: 12/500,137

(22) Filed: Jul. 9, 2009

(30) Foreign Application Priority Data
Sep. 12, 2008 (TW) 097135232

(51) Int. Cl. G06F 12/16; G06F 7/00

(52) U.S. Cl. 707/640; 711/162; 711/E12.001; 711/E12.103

(57) ABSTRACT

A data backup system can analyze the data that need backups in accordance with user-defined or default backup criteria, so that the user can locate the files in need of backup without spending lots of time on finding the files.

### BACKGROUND OF THE INVENTION

1. Field of the Invention

This invention relates to a data backup system; more particularly, this invention relates to a smart backup system.

2. Description of the Prior Art

The backup process of a conventional data backup system is illustrated in FIG. 1. The conventional data backup system saves backups of files selected by the user and then saves backups of modified files of the selected files. However, when the user forgets to backup certain files that have been modified, the backup system becomes vulnerable to losing files which are modified after last backup.

Moreover, in the case that the data backup system saves backups of all data/files, i.e. any new files and opened files, instead of the files selected by the user or by analyzing the operation behavior of the user, such a backup process will waste a large amount of storage space of a storage device and degrade the performance of the data backup system. Therefore, a more user-friendly backup device is desired to assist users in finding the data that need backups and reminding the users to backup the data from time to time or upon turning off the data processing system, so as to reduce the possibility of losing important data.

### SUMMARY OF THE INVENTION

The object of this invention is to provide a data backup system and a method thereof to improve the backup efficiency.

Another object of this invention is to provide a data backup system and a method thereof to enhance the user friendliness.

Another object of this invention is to provide a data backup system and a method thereof, which is able to analyze and provide more appropriate backups.

The objects and the solutions of this invention are achieved by analyzing operation behaviors of a user to determine files in need of backup and then classify the files in a backup list based on the file extension, so that the user can decide whether to backup the files on the backup list upon turning off the data processing system or at a time point defined by the user. Moreover, the user can find latest modified or opened files through this data backup system without knowing access paths, and accordingly, the time spending on finding the files in need of backup or searching the latest backup files can be saved. Furthermore, even when different applications are executed to cause changes in access paths, the user can readily find the files in need of backup through the data backup system.

This invention utilizes a data monitoring unit to obtain data change information between two time points from the data processing system that needs backup. Moreover, this invention also utilizes a processing unit to analyze the obtained data change information to generate a backup proposal including the files possibly in need of backup, so that the user can select the files in need of backup upon turning off the data processing system or at a time point defined by the user. Therefore, the files in need of backup can be managed in a user-friendly manner.

### BRIEF DESCRIPTION OF THE DRAWINGS

FIG. 1 is a flow chart of a conventional backup process.

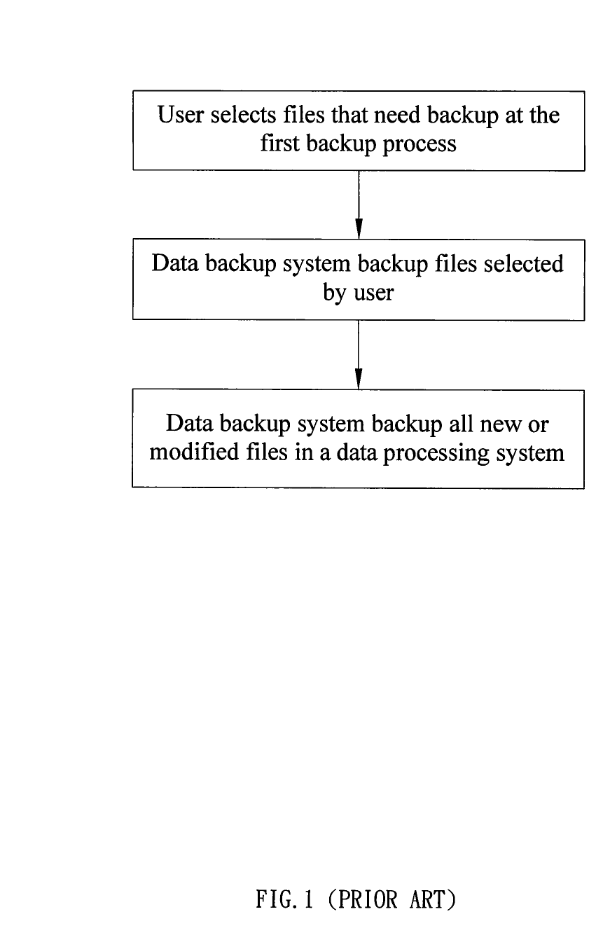

FIG. 2A is a block diagram of components of a data backup system in accordance with one embodiment of the present invention.

FIG. 2B is a block diagram of components of a data backup system in accordance with another embodiment of the present invention.

FIG. 2C is a block diagram of components of the data backup system in accordance with yet another embodiment of the present invention.

FIG. 3 is a flow chart of a backup process of the data backup system of the present invention.

FIG. 4 schematically illustrates an example of a data backup shelf of the data backup system of the present invention.

FIG. 5A is a flow chart of a backup process of the data backup system, which determines if any backup is required based on the analysis of the change in file quantity.

FIG. 5B is a flow chart of a backup process of the data backup system, which determines if any backup is required based on the analysis of the change in file size.

FIG. 5C is a flow chart of a backup process of the data backup system, which determines if any backup is required based on the analysis of the change in file-opening frequency.

FIG. 6 is a flow chart of the operation procedure that a user establishes backup criteria for the data backup system in accordance with one embodiment of the present invention.

FIG. 7 illustrates a flow chart of the operation of the data backup shelf of the data backup system.

### DETAILED DESCRIPTION OF THE PREFERRED EMBODIMENT

This invention provides a data backup system. In one embodiment, this invention can automatically ask a user whether to perform backup of files that meet backup criteria, i.e. reach the backup threshold value, by displaying a backup list upon turning off the data processing system or at other suitable time points determined by the user. In another embodiment of the data backup system, the user can define the backup criteria based on preference, and when changes in data reach the threshold value defined by the user, the data backup system can automatically perform backup of the data. The data backup system can also provide a backup proposal indicating the data in need of backup based on the backup criteria when the user initiates a backup procedure. The backup criteria may include, but are not limited to, characteristics of files, backup frequency which is a time interval of performing the backup process (e.g. a half hour, an hour, or two hours), etc. In one embodiment, the backup threshold value can be an amount of change in file quantity, file size, or file-opening frequency, or a combination thereof. In another embodiment, the backup threshold value can be a ratio of change in file quantity, file size, or file-opening frequency within a time period, such as the duration from turning on to turning off the data process system or any time period specified by the user. For example, the change in file size or file-opening frequency of a specific file or the change in file quantity of a specific type of file is the top 30% among all changes for all files. Based on such backup criteria, the data backup system can initiate a backup process even when the user only makes little modification for a long duration.

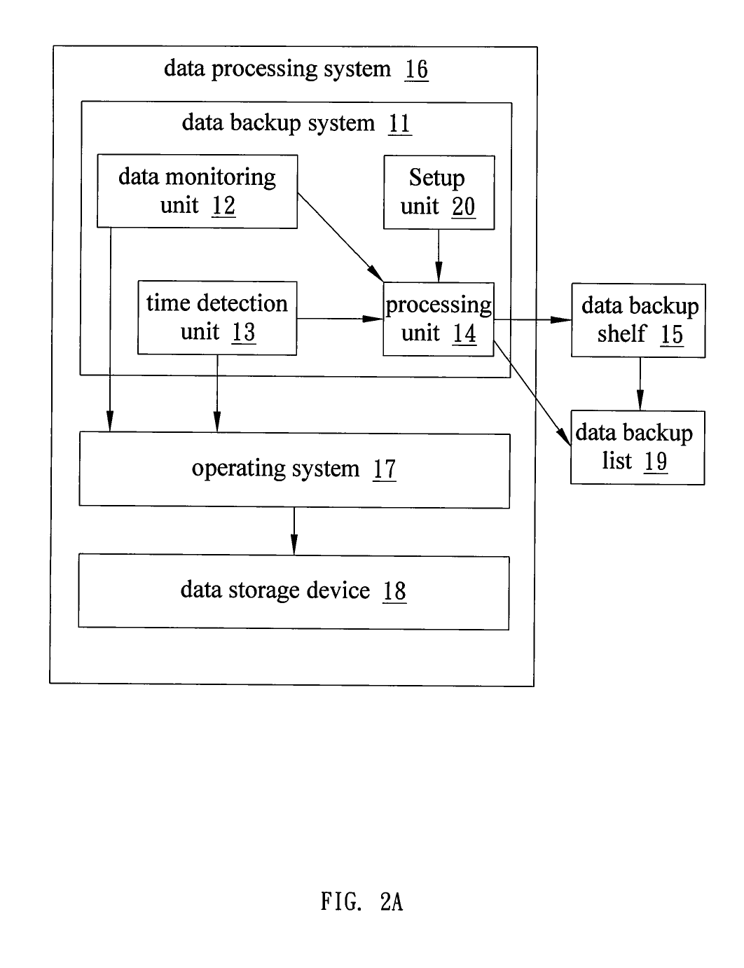

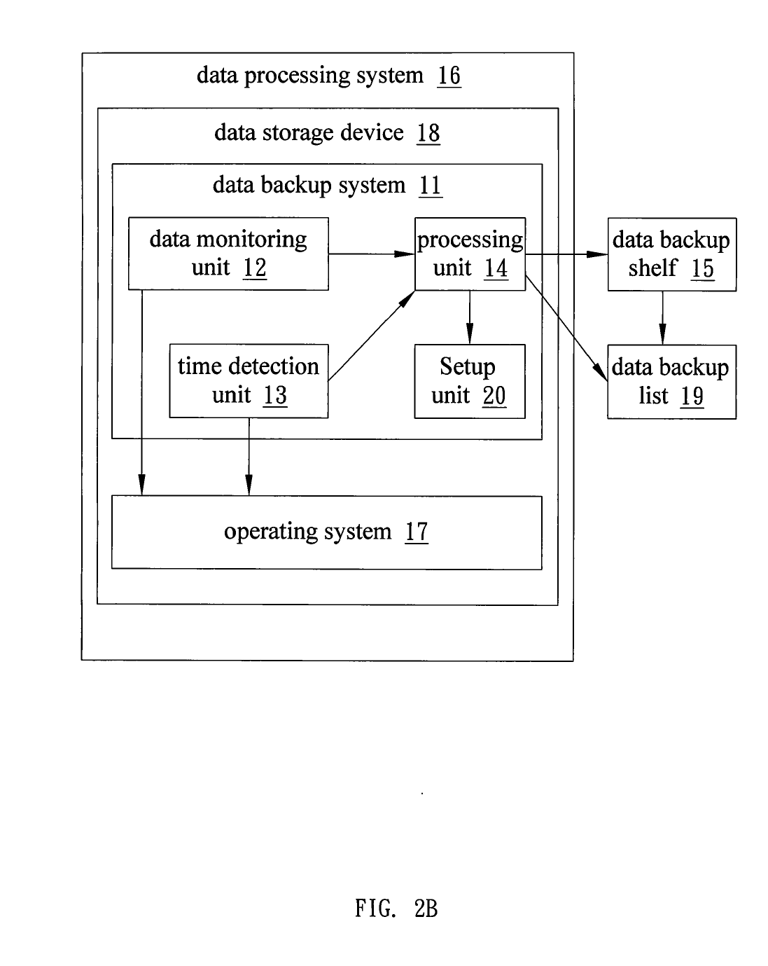

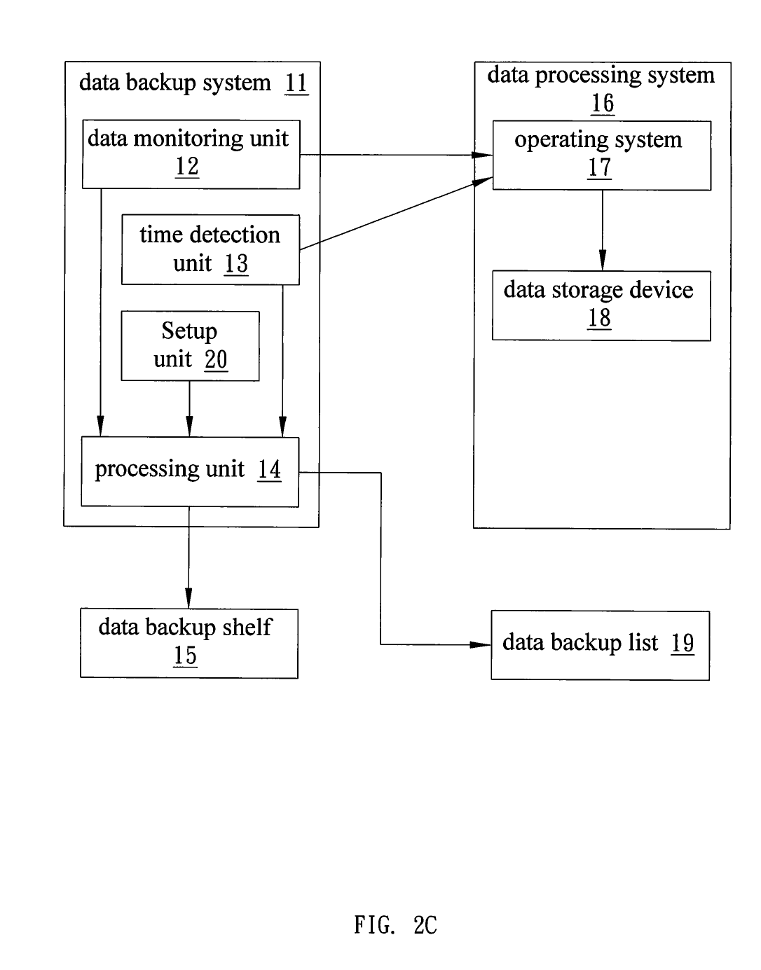

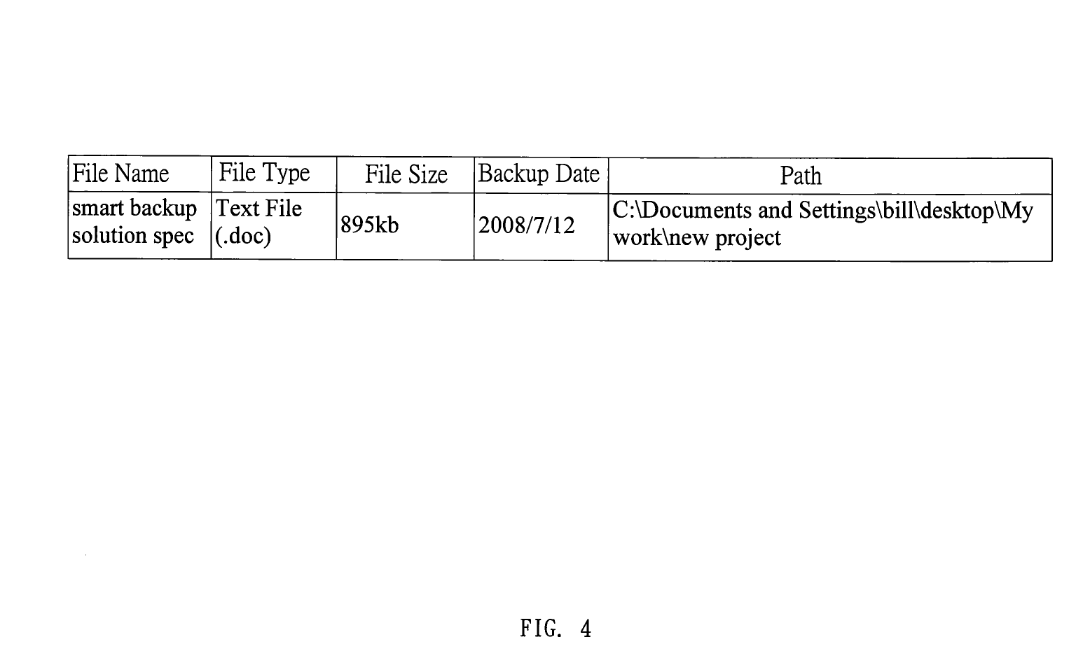

Moreover, this invention provides a data backup system 11 (see FIGS. 2A, 2B, and 2C), which provides a data backup shelf 15 (see FIG. 4) for the user to directly access the previous backup files without knowing the access path of applications. The data backup shelf 15 is a device of organizing previous backup files in a list, so that the user can select file(s) from the list when the user intends to access the previous backup data. The data backup shelf 15 can be achieved by designing Windows Programming incorporated with databases or any other suitable methods.

All the functions described above will be further explained and illustrated with the accompanying drawings and the following embodiments.

FIGS. 2A, 2B, and 2C are block diagrams of components in accordance with various embodiments of this invention. The data backup system 11 includes a data monitoring unit 12, a processing unit 14, a setup unit 20, and a time detection unit 13. The data backup system 11 can be installed in personal computers, notebooks, on-board computers, personal digital assistants (PDAs), and any data processing system in need of data backup. For example, the data backup system 11 can be operated with a data processing system 16, which is provided with an operating system 17 and a data storage device 18, to achieve a user-friendly backup. Apart from the types of the data processing system 16 mentioned above, the data processing system 16 can also be a central processing unit (CPU) or software executed for operation. The operating system 17 can be Windows 95, Windows NT, Windows 2000, Linux, or any other operating system that an ordinary person skilled in the art is familiar with. Moreover, the data storage device 18 can be a hard drive, a portable hard drive, a compact flash (CF) card, a memory card, a compact disc (CD), a magnetic tape drive, a flash stick, or any other storage unit that an ordinary person skilled in the art is familiar with. In this embodiment, the data backup system 11, as illustrated in FIG. 2A, is included in the data processing system 16 and is independent from the operating system 17. However, in other embodiments, as shown in FIG. 2B, the data backup system 11 and the operating system 17 are both included in the data storage device 18, and the operating system 17 is independent from the data backup system 11. Moreover, in other embodiments, as shown in FIG. 2C, the data backup system 11 can be independent from the data processing system 16 or be an application executed in the operating system 17. The embodiments above only show several arrangements of the elements. Other arrangements which can be easily contemplated by an ordinary person skilled in the art are considered within the scope of the invention. In the embodiments shown in FIGS. 2A, 2B, and 2C, the operating system 17 in the data processing system 16 can monitor changes of the data storage device 18 at all times by program control (e.g. API (application programming interface)). The data monitoring unit 12 can directly monitor the operating system 17 and obtain data change information of the data storage device 18 from the data processing system 16 by using programs (e.g. the function get(Calendar.HOUR_OF_DAY) provided by the operating system). The data change information may include a change in file quantity, a change in file size, or a change in file-opening frequency within a specific time period. For example, the data change information may include the change in file quantity of a specific type of file, the change in file size or file-opening frequency of a specific file within the duration from turning on to turning off the data processing system 16 or any time period specified by the user. Moreover, the files herein can include word files, audio files, compressed files, video files, or any other types of files. The setup unit 20 can store a set of backup criteria which can be default settings or defined by the user to serve as the backup threshold value. The backup criteria may include criteria associated with file quantity, file size, and/or file-opening frequency for a specific type of file or for one or all files. The time detection unit 13 obtains time information of the processing system 16 monitored by the operating system 17 by program functions (e.g. get(Calendar.HOUR_OF_DAY)). The time information is about the time period, such as from a first time point to a second time point, during which the operating system 17 monitors changes in data of the data processing system 16. In other embodiments, the time detection unit 13 of the data backup system 11 can directly obtain the time information from the hardware (e.g. BIOS) of the data processing system 16, instead of the operating system 17, through program languages (e.g. through API).

The data monitoring unit 12, the setup unit 20, and the time detection unit 13 then transfer the data change information, the backup threshold value (i.e. the backup criteria), and the time information to the processing unit 14. After processed by the processing unit 14, the data change information within a time period (e.g. the time period from turn on to turn off or any time period defined by the user) and in turn a data variation per unit of time can be obtained. Moreover, the processing unit 14 compares the backup threshold value with the data variation per unit of time of a specific file or a specific type of file to determine whether to include the file(s) in the backup list 19. Then, the backup list 19 is presented in a backup proposal upon turning off the processing system 16 or at a time point defined by the user, so that the user may select the file(s) for backup from the backup list 19. Moreover, if it is desired, the backup files can be classified based on the file extension (e.g. word files, audio files, compressed files, video files, and any types of files), sorted by the backup date or backup time, and put on the data backup shelf 15 for the user to select for subsequent operations. The processing unit 14 preferably includes a processor. In this embodiment, the operating system 17 and the data backup system 11 can use a common processing unit, as shown in FIG. 2A and FIG. 2B, or use separate processing units, as shown in FIG. 2C. Moreover, in different embodiments, the processing unit 14 can be an operation module of a program, which outputs corresponding data after processing the input data.

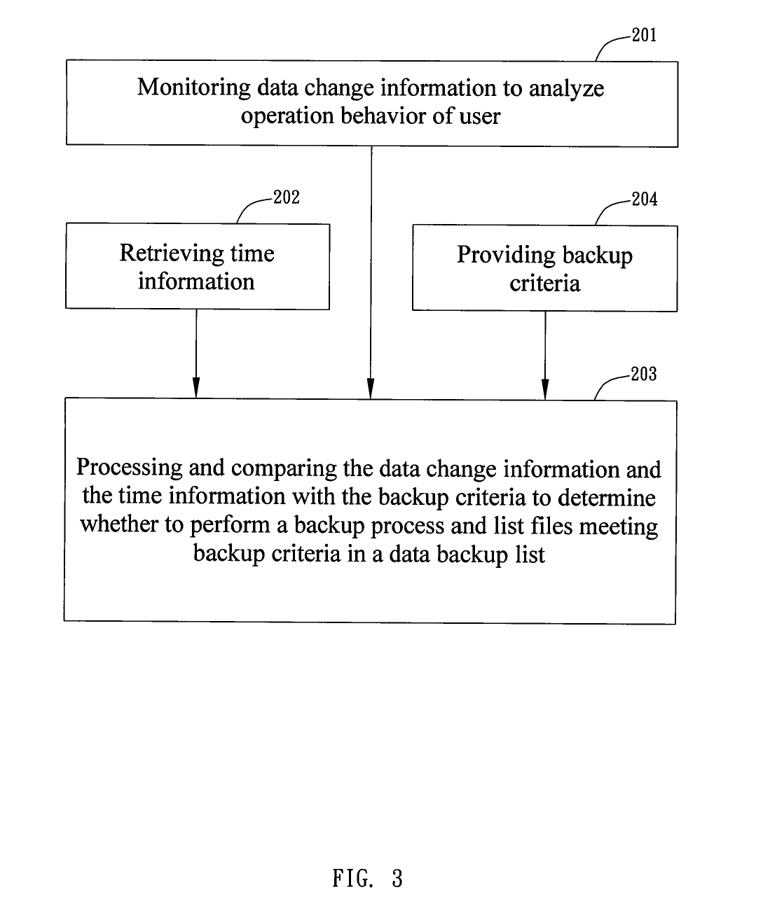

FIG. 3 illustrates a flow chart of an analysis process of the data backup system 11. Step 201 includes monitoring data change information to analyze the operation behavior of the user. In one embodiment, the operating system 17 of the data processing system 16 monitors all kinds of data change in the data storage device 18 at all times, and the data monitoring unit 12 of the data backup system 11 directly monitors and obtains the data change information from the operating system 17. The data change information includes changes in file quantity, file size, file-opening frequency, etc. within a time period from a first time point to a second time point. Furthermore, as mentioned above, the data change information can be a ratio of change in file quantity of a specific type of file or change in file size or file-opening frequency of a specific file or a specific type of file among all data changes within the time period (e.g. the data change in file size or file-opening frequency of a specific file or the change in file quantity of a specific type of file is the top 30% among all changes for all files). The data change information serves as a basis for determining whether to perform a backup procedure. Step 202 includes retrieving time information. For example, the operating system 17 of the data processing system 16 can have a timing function, and the data backup system 11 directly obtains two time points from the operating system 17 (e.g. a turn on time point and a turn off time point), that is the time information. The time information can be obtained through program languages (e.g. get (Calendar.HOUR_OF_DAY)) or signal transmissions. In other embodiments, the time detection unit 13 of the data backup system 11 can directly obtain the time information from the hardware (e.g. BIOS) of the data processing system 16, instead of the operating system 17, through programming languages (e.g. API). Step 204 includes providing backup criteria, which can be default settings or defined by the user. Then, in step 203, the obtained data change information, the obtained time information, and the backup criteria being default or defined by the user (i.e. the backup threshold value) are transferred to the processing unit 14. After processed by the operation unit in the processing unit 14, the data variation per unit of time is obtained. The backup threshold value can be a numeral value or a percentage (e.g. the percentage of the change in file quantity of a specific type of file or changes in file size or file-opening frequency of a specific file among all data changes, for example, the top 30% among all data changes). Then, the obtained data variation per unit of time is compared with the backup threshold value. When the data variation per unit of time exceeds the backup threshold value, the processing unit 14 classifies the files based on the file extensions, sorts the files according to the last backup time, and includes the files in the backup list 19. Upon the user turning off the processing system 16 (e.g. a computer) or at a time point defined by the user, the processing unit 14 provides a backup proposal including the backup list 19 to propose the user for backup of these files. Then, the user may determine what files on the backup list 19 are in need of backup. Additionally, if the user prefers to backup the files more frequently, the data backup system 11 may display the backup list 19 at intervals (e.g. every 30 minutes) so that the user may select the files in need of backup. Alternatively, if desired, the data backup system 11 may automatically perform backups for the files on the backup list 19.

FIG. 4 schematically illustrates an example of a data backup shelf of this invention. This invention further provides a data backup shelf 15 for the user to conveniently search files. The data backup shelf 15 is a list of previous backup files classified based on the file extension and sorted by the backup time, and the list is displayed in a form of browsing window or table. The user can directly search the previous backup files through the data backup shelf 15 without knowing the access paths of the files, and the processing unit 14 of the data backup system 11 automatically searches the data storage device 18, such as CD, the magnetic tape drive, or the hard drive for the files selected by the user. Therefore, the user can locate the latest backup files easily and quickly. The data backup shelf 15 of this embodiment includes name, type, size, backup date, and access path of the file. However, in other embodiments, the content of the data backup shelf 15 can include other information, for example, a preview image of the file or a previous backup version of the backup file. The data backup shelf 15 can be achieved through program design (e.g. Windows programming and databases) or other similar methods. The data backup shelf 15 can be achieved by other methods such as signal transmissions or hardware applications.

This invention also provides an automatic backup function and a user setup function. The setup unit 20 of the data backup system 11 may include default backup criteria so that the data backup system 11 can backup new, modified, or opened files within a certain time period based on file-increasing speed, file-modified frequency, or any other criteria. Moreover, the user can define the backup interval through the setup unit 20 of the data backup system 11. Also, other backup methods can be applied. For example, the user can backup all selected files and folders or only backup new or modified files from last backup. Therefore, the user can choose any backup method that is most advantageous or based on preference.

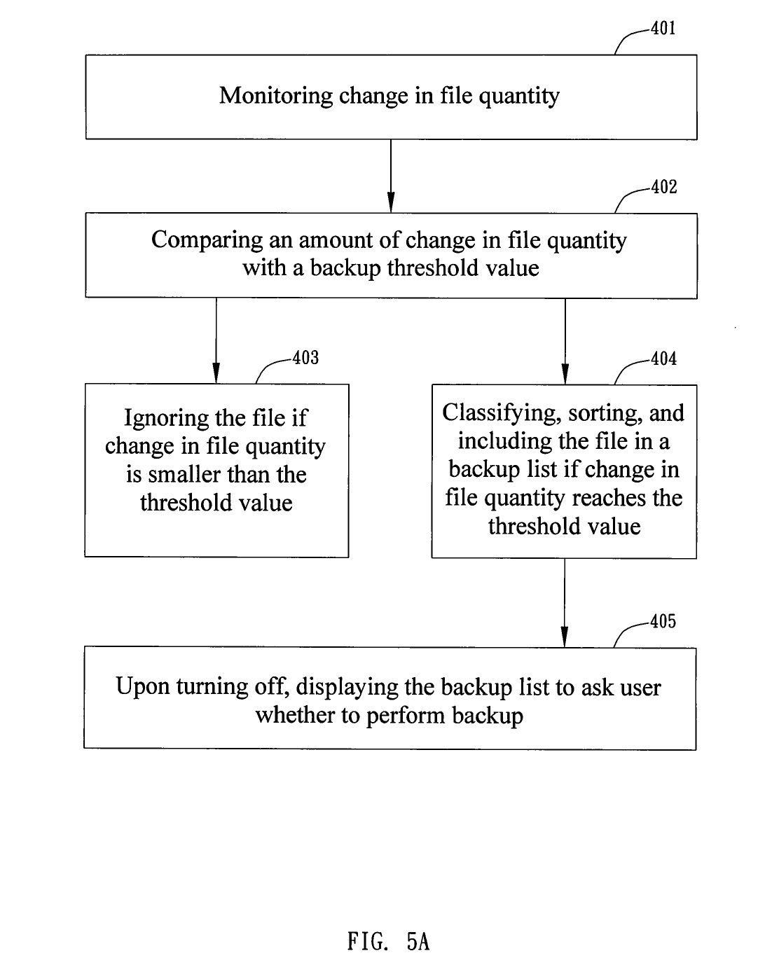

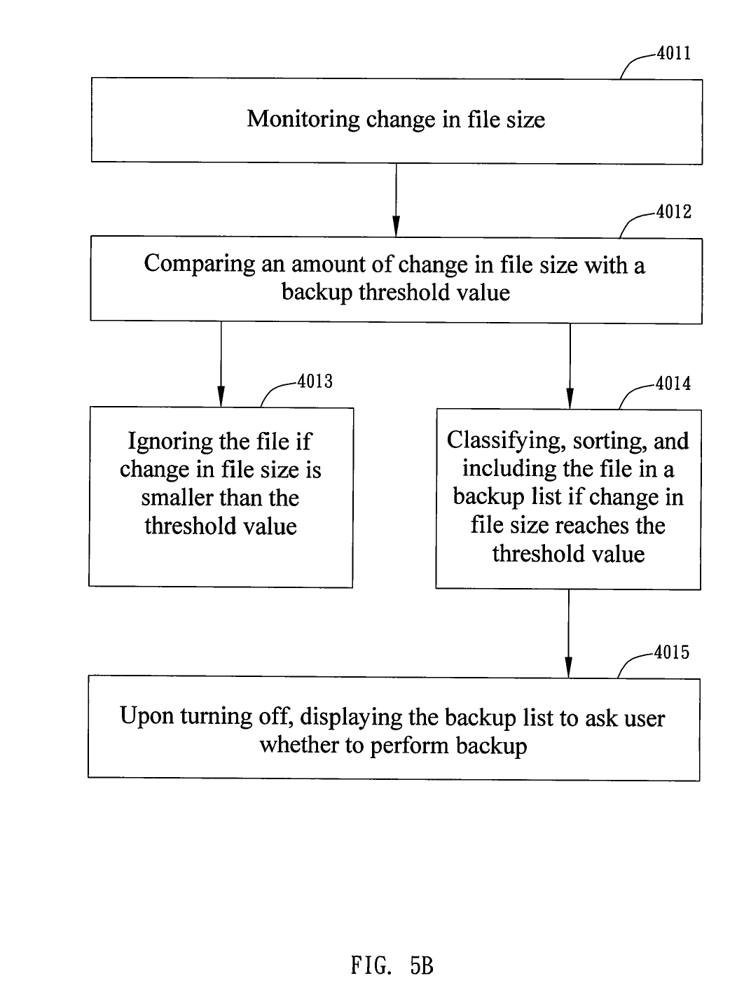

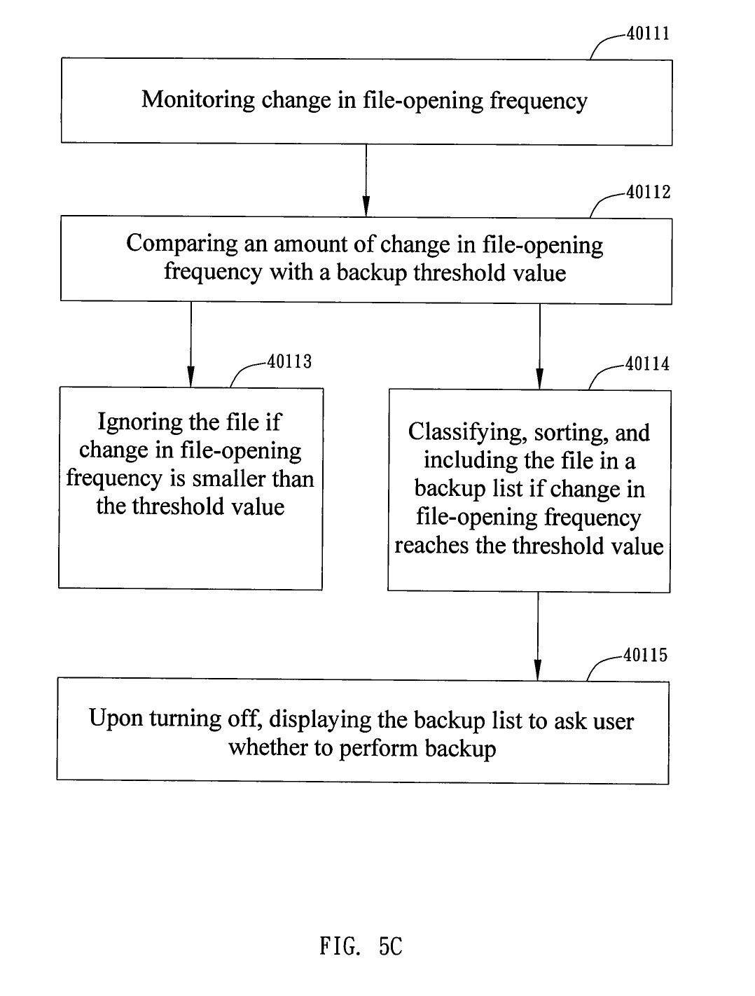

FIG. 5A is a flow chart of an embodiment of the data backup method of this invention. In step 401, the backup system monitors the file quantity through the data monitoring unit 12 disposed therein. The changes in file quantity are analyzed to obtain the operation behavior of the user in accordance with the percentage of the change in file quantity of a specific type of file among total data changes during turning on and turning off. However, in other embodiments, the changes in file quantity can be analyzed based on the amount of change in file quantity of a specific type of file with in a predetermined time period. Then, the data change information is transferred to the processing unit 14. In step 402, the processing unit 14 compares the data change information with the backup threshold value pre-defined in the processing unit 14 to determine whether to initiate a backup procedure. That is, the processing unit 14 determines whether to initiate the backup process based on the comparison of the change in file quantity of a specific type of file with the backup threshold value. Alternatively, the processing unit 14 may determine whether to initiate the backup procedure in accordance with the comparison of the percentage of the changes in file quantity of a specific type of file among all changes in file quantity of all types of file with the backup threshold value. In step 403, if the change in file quantity is smaller than the threshold value, the files are ignored and a backup process for the files is not performed. In step 404, if the change in file quantity or the percentage of changes in file quantity reaches the threshold value, the files are classified based on the file extension, sorted by the stored time, and then included in the backup list 19. The backup list 19 can be in a form of window, table, file cabinet, or any measure for organizing the files. In step 405, upon turning off the data processing system, the user is asked whether to backup the files listed in the backup list 19. Finally, backups of the selected files are stored in the data storage device 18 (e.g. CF card, hard drive, CD, or magnetic tape drive).

FIG. 5B is a flow chart of an embodiment of this invention. In step 4011, the backup system monitors the change in file size through the data monitoring unit 12 disposed therein. The changes in file size are analyzed to obtain the operation behavior of the user in accordance with the percentage of the change in file size of a given file among total data changes in file size during turning on and turning off. However, in other embodiments, the data change information may be obtained based on an amount of change in file size of the given file within a predetermined time period. Moreover, the data change information (e.g. changes in file size) can be transferred to the processing unit 14. In step 4012, the processing unit 14 compares the data change information with the pre-defined backup threshold value to determine whether to initiate a backup process. That is, the processing unit 14 compares the change in file size with the threshold value pre-defined in the processing unit 14 to determine whether to initiate the backup procedure. Alternatively, the processing unit 14 may determine whether to initiate a backup procedure in accordance with the percentage of the changes in file size of the given file among all changes in file size (e.g. the percentage of the change in file size of a specific file is in the top 30% of all changes in file size). Apart from the two methods stated above, other operation methods can be applied to determine whether to backup the files. In step 4013, if the change in file size is smaller than the threshold value, the file is ignored and the backup process for the file will not be performed. In step 4014, when any file has change in file size reaching the threshold value, the files are classified based on the file extension, sorted by the stored date, and then included in the backup list 19. The backup list 19 can be in a form of window, table, file cabinet, or any measure for organizing the file. In step 4015, upon turning off the data processing system, the user is asked whether to backup the files listed in the backup list 19, and then backups of the files selected by the user are stored in the data storage device 18 (e.g. CF card, hard drive, CD or magnetic tape drive).

FIG. 5C is a flow chart of an embodiment of the data backup method of this invention. In step 40111, the backup system monitors the change in file-opening frequency through the data monitoring unit 12 disposed therein. The changes in file-opening frequency are analyzed to obtain the operation behavior of the user in accordance with the percentage of the change in file-opening frequency of a given file among total data changes in file-opening frequency during turning on and turning off. However, in other embodiments, the data change information may be obtained based on an amount of change in file-opening frequency of the given file within a predetermined time period. Moreover, the data change information (e.g. changes in file-opening frequency) can be transferred to the processing unit 14. In step 40112, the processing unit 14 compares the data change information with the pre-defined backup threshold value to determine whether to initiate a backup process. That is, the processing unit 14 compares the change in file-opening frequency with the threshold value provided in the processing unit 14 to determine whether to initiate the backup procedure. Alternatively, the processing unit 14 may determine whether to initiate the backup procedure in accordance with the percentage of the change in file-opening frequency of the given file among all changes in file-opening frequency (e.g. the percentage of the change in file-opening frequency of a specific file is in the top 30% of all changes in file-opening frequency). In step 40113, if the change in file-opening frequency is smaller than the threshold value, the given file is ignored and the backup process for the file will not be performed. In step 40114, when any file has change in file-opening frequency reaching the threshold value, the files are classified based on the file extension, sorted by the stored date, and then included in the backup list 19. The backup list 19 can be in a form of window, table, file cabinet, or any measure for organizing the file. In step 40115, upon turning off the data processing system, the user is asked whether to backup the files listed in the backup list 19, and then backups of the files selected by the user are stored in the data storage device 18 (e.g. CF card, hard drive, CD or magnetic tape drive). Moreover, the data monitoring unit 12 can monitor all the data changes mentioned above simultaneously. When one or more of the changes meets one or more of the backup criteria, the processing unit 14 of the data backup system 11 includes the files in the backup list 19 and asks the user whether to backup the files upon turning off the data processing system 16 or at a predetermined time point. At last, backups of the files selected by the user will be stored in the data storage device 18 (e.g. CF card, hard drive, CD or magnetic tape drive). Please note, in the embodiments described above, the backup criteria independently relate to the file quantity, the file size, and the file-opening frequency; however, in other embodiments, the above-mentioned criteria may be used in a combination manner.

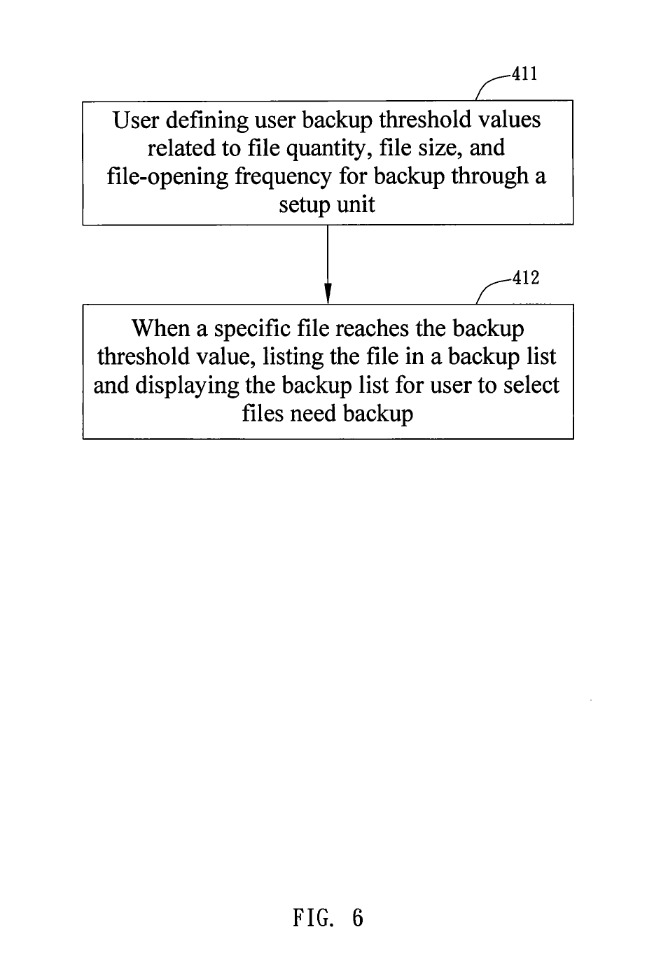

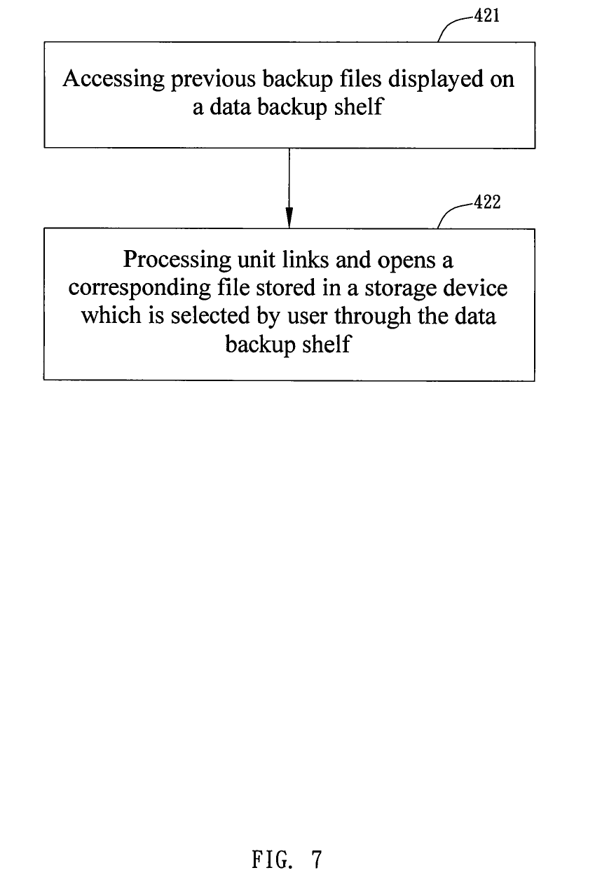

FIG. 6 is a flow chart of another embodiment of this invention. This embodiment relates to defining the backup criteria by the user. That is, the user can define the backup threshold value through the setup unit 20 (step 411). The data monitoring unit 12 transfers the data change information obtained from the operating system 17 and the backup threshold value provided through the setup unit 20 to the processing unit 14. After that, the processing unit 14 compares the data change information received from the data monitoring unit 12 with the threshold value defined through the setup unit 20. Once the backup criteria are met, the data backup system 11 automatically backups the files that meet the backup criteria (step 412). Moreover, the user can activate the automatic backup function at a regular interval (e.g. 30 minutes, 1 hour, or 2 hours). Moreover, the backup method can be divided into full backup, differential backup, and incremental backup, which are to backup all the selected files and folders, backup only the new or modified files from the last complete backup, and backup only the new or modified files from the last differential backup, respectively. FIG. 7 illustrates a flow chart of another embodiment of this invention. When the user executes a plurality of applications and each application has its own default access path, it is inconvenient for the user to remember the access path of each application. In this data backup system 11, there is no need for the user to remember the default access path of each application. The user can directly access the latest backup files which are classified based on the file extension and sorted by the stored date without knowing the access paths of the files. First of all, the user selects the data backup shelf 15 from the data backup software. The processing unit 14 of the data backup system 11 displays the data backup shelf 15 for the user to select previous backup files (step 421). The data backup shelf 15 can be in a form of window, table, file cabinet, or any measure of organizing the files, and each file on the data backup shelf 15 is linked to a corresponding file. Then, the processing unit 14 of the data backup system 11 locates and opens the file selected by the user from the data storage device 18 using the link (e.g. in Java programming, the function can be achieved by file output stream) (step 422). Moreover, in other embodiments, the data backup system 11 can further add corresponding tracing files (e.g. tracking cookies) in the backup files so as to conveniently trace the access paths of files. Therefore, the processing unit 14 of the data backup system 11 can easily locate the files selected by the user in the add of the tracking files even after the access paths have been changed during the operation of the data processing system 16.

Although this invention is disclosed with the description and the embodiments above, they are not intended to limit this invention. Any ordinary skilled person in the art can make any changes or modifications within the spirit and scope of this invention; there, the protected scope of this invention should be defined in accordance to the appended claims.

What is claimed is:

1. a data backup system for use with a data processing system, the data backup system comprising:
a data monitoring unit for obtaining data change information between a first time point and a second time point from the data processing system; and
a processing unit for creating a backup proposal based on the data change information.

2. The data backup system of claim 1, wherein the data processing system includes an operating system, the data monitoring unit obtains the data change information of a given file from the operating system.

3. The data backup system of claim 1, wherein the data monitoring unit monitors data stored in a storage device and retrieves changes at least in one of file quantity, file size, and file-opening frequency of the data between the first time point and the second time point to obtain the data change information.

4. The data backup system of claim 1, wherein the data processing system has a specific data type, the data monitoring unit records an amount of data change of the specific data type to serve as the data change information.

5. The data backup system of claim 4, wherein the amount of data change includes an amount of change in at least one of file quantity, file size, and file-opening frequency to serve as the basis of the data change information.

6. The data backup system of claim 1, wherein the processing unit includes backup criteria, and the data change information is compared with the backup criteria to create the backup proposal.

7. The data backup system of claim 6, wherein the backup criteria includes a threshold value associated with a change in at least one of file quantity, file size, and file-opening frequency.

8. The data backup system of claim 1, further comprising:
a time detection unit for retrieving time information about the first time point and the second time point from the data processing system,
wherein the processing unit processes the time information and the data change information to obtain a data variation per unit of time, and then the processing unit creates the backup proposal based on the data variation per unit of time.

9. The data backup system of claim 1, wherein the data monitoring unit monitors a file-opening frequency of a specific data type.

10. The data backup system of claim 7, wherein when any one of the following conditions is met, data of a specific data type are listed in a backup list of the back proposal for automatic backup or manual backup when turning off the processing system or at a time point set up by the user:
when the processing unit obtains from the data change information indicating that a file-opening frequency of the specific data type exceeds the threshold value;
when the processing unit obtains from the data change information indicating that a change in file quantity of the specific data type exceeds the threshold value; and
when the processing unit obtains from the data change information indicating that a change in file size of the specific data type exceeds the threshold value.

11. The data backup system of claim 1, further comprising a setup unit for a user to set up a backup criteria, wherein when the data change information of a given file obtained by the monitoring unit meets the backup criteria, the data backup system backup the given file.

12. The data backup system of claim 1, further comprising an automatic backup function for automatically performing backups of new data based on the data change information between the first time point and the second time point obtained by the monitoring unit form the data processing system.

13. The data backup system of claim 1, further comprising an automatic backup function for automatically performing backups of modified data when a file-opening frequency of a specific file exceeds a given file-opening frequency within a given time period.

14. The data backup system of claim 1, wherein the processing unit further provides a data backup shelf to list previous backup data.

15. A method for data backup, comprising:
providing backup criteria including a backup threshold value in a processing unit of a data backup system;
monitoring data stored in a storage device by a monitoring unit of the data backup system to obtain data change information between a first time point and a second time point from a data processing system; and
comparing the data change information with the backup threshold value based on time information specifying the first time point and the second time point to create a backup proposal.

16. The data backup method of claim 15, wherein the data change information is obtained by retrieving at least one of a change in file quantity, a change in file size, and a change in file-opening frequency between the first time point and the second time point.

17. The data backup method of claim 15, further comprising:
retrieving the time information specifying the first time point and the second time point;
determining a data type for backup by a setup unit;
recording an amount of data change of the data type to serve as the data change information; and
generate a data variation per unit of time, wherein the backup proposal is created based on the data variation per unit of time.

18. The data backup method of claim 17, further monitoring a change in file-opening frequency of the data type to automatically backup files of the data type or to display a backup list for a user to initiate a backup process when the change in file-opening frequency exceeds the backup threshold value.

19. The data backup method of claim 17, further monitoring a change in file quantity of the data type to automatically backup new files of the data type when the change in file quantity exceeds the backup threshold value.

20. The data backup method of claim 17, further monitoring a change in file size of the data type to automatically backup files of the data type or to display a backup list for a user to initiate a backup process when the change in file size exceeds the backup threshold value.
